(19) United States
(12) Patent Application Publication
(10) Pub. No.: US 2026/0160111 A1
(43) Pub. Date: Jun. 11, 2026

(54) LID DEVICE

(71) Applicant: U-Shin Ltd., Nagano (JP)

(72) Inventors: Yuki TANAKA, Hiroshima City (JP); Mitsuru WATANABE, Hiroshima City (JP); Takashi FUKUE, Hiroshima City (JP)

(21) Appl. No.: 19/401,714

(22) Filed: Nov. 26, 2025

(30) Foreign Application Priority Data
Dec. 9, 2024 (JP) 2024-214568

(51) Int. Cl. E05F 15/63; B60L 53/16

(52) U.S. Cl. CPC E05F 15/63; B60L 53/16; E05Y 2900/534

(57) ABSTRACT

The present application improves an appearance of a lid. In a lid device, when the lid is rotated toward a closed position, a lifter presser of the lid presses a lifter knob toward other side in rotation direction by a drive of an actuator. The lifter knob is biased forward by a lifter spring and held in a lift position. Here, a biasing force on the lifter knob in the lift position by the lifter spring is set larger than a pressing force on the lifter knob by the lifter presser. Therefore, in the closed position of the lid, the lifter presser is always in contact with the lifter knob in the lift position. Therefore, a positional variation of the lid in front-back direction in the closed position of the lid can be suppressed. Therefore, the appearance of the lid in the closed position can be improved.

### CROSS-REFERENCE TO RELATED APPLICATIONS

This application claims the benefit of Japanese Application No. 2024-214568, filed Dec. 9, 2024, the entire disclosure of which is hereby incorporated herein by reference.

### TECHNICAL FIELD

The present invention relates to a lid device.

### BACKGROUND ART

In an energy receiver (lid device) of a vehicle of Patent Literature 1 below, a receiving recess is provided on an inside the vehicle at an opening of the vehicle. A lid is provided outside of the vehicle in the receiving recess, and the lid is rotated between a first position to open the opening of the vehicle and a second position to close the opening by driving an actuator. In the second position of the lid, when the lid is pushed toward the inside of the vehicle by an operator, a switch in the receiving recess is pressed. This causes the actuator to be driven by a controller and the lid to rotate from the second position to the first position. The lid has a magnet and the receiving recess has a magnetic detector. The controller detects the second position of the lid when the magnetic detector detects magnetism by the magnet. When the lid is rotated from the first position to the second position, the controller detects the second position based on the detection result of the magnetic detector and stops driving the actuator.

### PATENT LITERATURE

Japanese Unexamined Patent Application Publication No. 2022-183919

### SUMMARY OF INVENTION

### Technical Problem

However, there is room for improvement in the energy receiver of the above vehicle in the following points. That is, in the energy receiver of the above vehicle, an elastic annular seal member is provided in the receiving recess. In the second position of the lid, the lid presses the seal member, the seal member is elastically deformed, and the seal member seals the space between the receiving recess and the lid.

Here, a hardness of the seal member changes with changes in ambient temperature. That is, the hardness of the seal member increases as the ambient temperature becomes colder. As the hardness of the seal member increases, a force to elastically deform the seal member also increases. On the other hand, since a driving force of the actuator is constant, the force with which the lid presses down on the seal member is also constant. Therefore, when the ambient temperature is low, positional variations of the lid may occur in the second position of the lid. Specifically, for example, when the lid is positioned outside the vehicle relative to the vehicle opening, there is a risk that the lid may contact the sealing member and stop before reaching the second position. This causes a surface of the lid to no longer be flush with the surface of the vehicle panel, which reduces an appearance of the lid.

The present invention takes facts described above into consideration to provide the lid device that can improve the appearance of the lid.

### Solution to Problem

One or more embodiments of the present invention is a lid device comprising:
a base provided inside an opening in a panel of a vehicle;
a lid operatively coupled to the base, positioned in a closed position on an obverse side of the base and closing the opening, and positioned in an open position to open the opening by operating from the closed position to one side in operating direction;
a driver coupled to the lid and driven to actuate the lid; and
a lifter mechanism provided on the base and the lid,
wherein, the lifter mechanism is configured to comprise:
a lifter member provided on the base that is movable in obverse-reverse direction of the base;
a lifter forcer that forces the lifter member toward an obverse side of the base;
a lifter holder that restricts a movement of the lifter member to the obverse side and holds the lifter member in a lift position; and
a lifter presser provided on the lid and presses and moves the lifter member to a reverse side of the base when the lid in the closed position is pushed to the reverse side of the base,
wherein, when the lid is operated from the open position to the closed position, the lifter presser presses the lifter member in the closed position toward other side in the operating direction by the driver, and a biasing force exerted on the lifter member in a lift position by the lifter forcer is greater than pressing a pressing force on the lifter member by the lifter presser.

### Advantageous Effect of Invention

One or more embodiments of the invention can improve an appearance of the lid.

### BRIEF DESCRIPTION OF DRAWINGS

FIG. 1 is a front view schematically illustrating a lid device according to the present embodiment, as viewed from a front side.

FIG. 2 is a cross-sectional view of a left portion of the lid device illustrated in FIG. 1 from a right side (cross-sectional view of the 2-2 line in FIG. 1).

FIG. 3 is the cross-sectional view illustrating a state in which the lid illustrated in FIG. 2 is rotated to an open position.

FIG. 4 is a reverse view of the lid device as viewed from a rear side illustrated in FIG. 1.

FIG. 5 is the cross-sectional view of an area around a switch unit illustrated in FIG. 4, viewed from the right side (cross-sectional view of the 5-5 line in FIG. 4).

FIG. 6 is an exploded view of the switch unit illustrated in FIG. 5.

### DESCRIPTION OF EMBODIMENT

A lid device 10 according to the present embodiment will be described below with reference to drawings. Arrows UP, FR, and RH illustrated in the drawings as appropriate indicate upper, front, and right sides of the lid device 10. In the following description, when directions up-down, front-back, and left-right are used, they shall indicate up and down, front and back, and left and right directions of the lid device 10, unless otherwise noted.

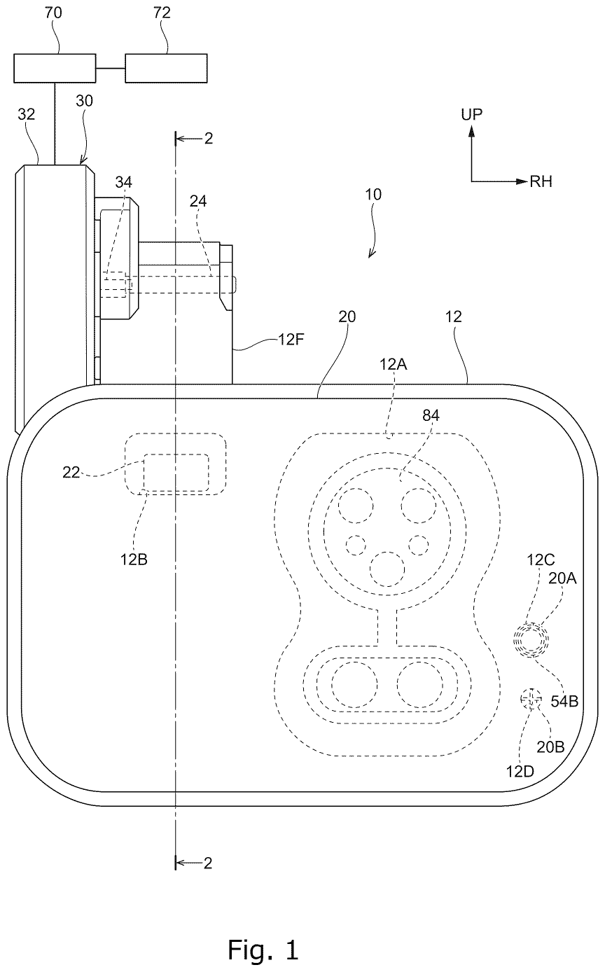

As illustrated in FIG. 1, the lid device 10 is provided at a side portion of a rear portion of a vehicle (automobile). The front-back direction of the lid device 10 coincide with vehicle width direction. The lid device 10 comprises a base 12, a lid 20, an actuator 30 as a driver, and a switch unit 40. Each configuration of the lid device 10 will be described below.

### Base 12

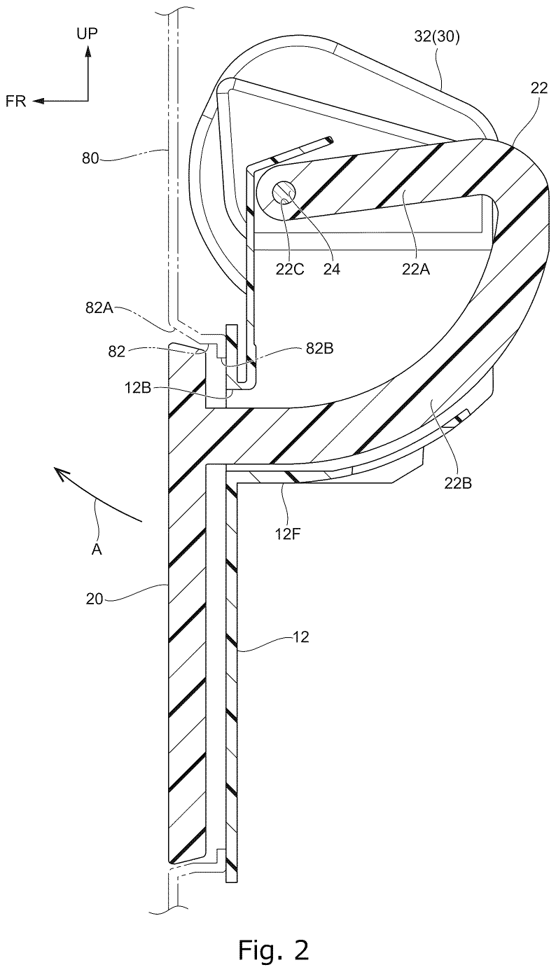

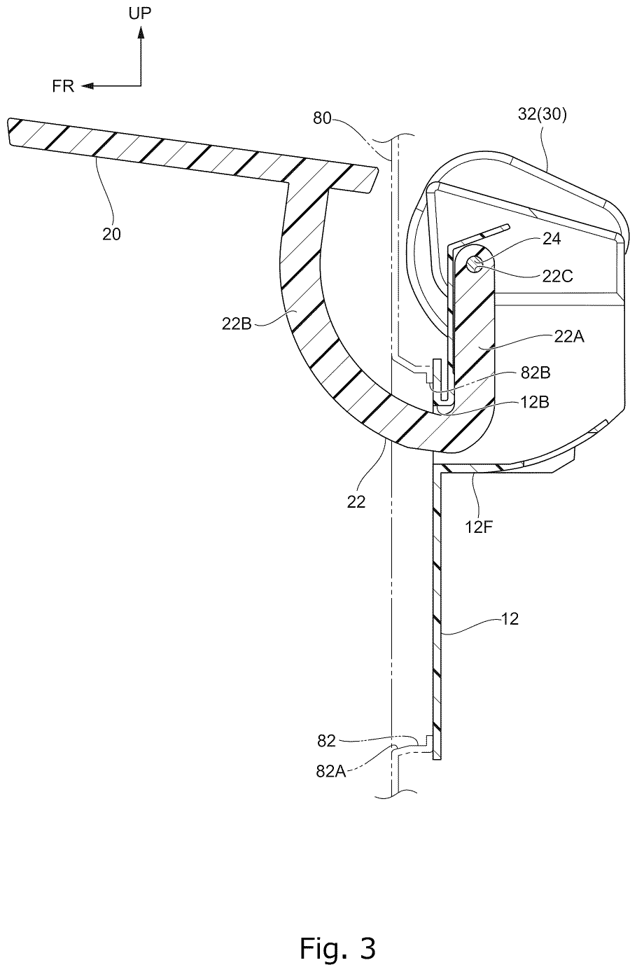

As illustrated in FIG. 1 to FIG. 4, the base 12 is provided at a rear side of a recess 82 (see FIG. 2 and FIG. 3) in an outer panel 80 as a panel of a vehicle. The recess 82 is formed in a concave shape open to a front side (outside of the vehicle width direction). The base 12 is formed in a substantially rectangular plate shape with the front-back direction as thickness direction, is disposed adjacent to the rear side of the recess 82, and is fixed to a vehicle body at a position not illustrated. As a result, the base 12 is positioned rearward (inside the vehicle width direction) relative to an opening 82A of the recess 82. An exposed hole 82B is formed in a bottom wall of the recess 82 to expose portions of the base 12 other than an outer circumference toward the front side.

A base hole 12A is formed through a right portion of the base 12 in the front-back direction. The base hole 12A is formed in a substantially long hole shape with the up-down direction as longitudinal direction. A portion of an energy receiver 84 (see FIG. 1) is disposed inside the base hole 12A, and the energy receiver 84 is exposed to the front side by the base hole 12A. An insertion hole 12B is formed through an upper end of a left portion of the base 12 for inserting a lid arm 22 described further below. The insertion hole 12B is formed in a substantially rectangular shape with the left-right direction as the longitudinal direction.

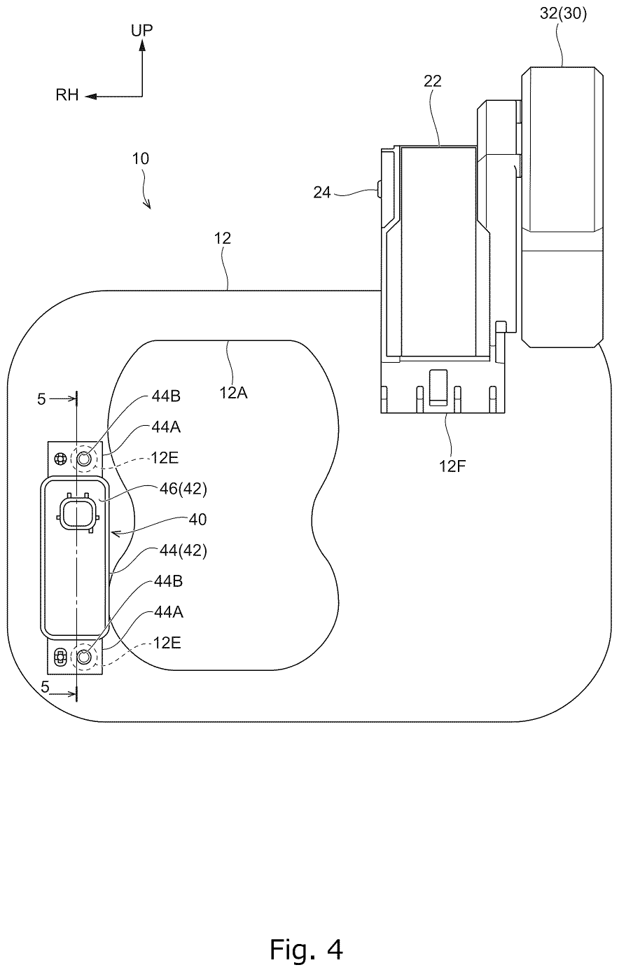

At a lower right end of the base 12, a circular-shaped switch hole 12C is formed through in the front-back direction on the right side of the base hole 12A. In addition, a circular lifter hole 12D is formed through the base 12 in the front-back direction at the lower side of the switch hole 12C. On the rear (reverse) surface of the base 12, there are a top and bottom pair of fixing bosses 12E (see FIG. 4). The fixing bosses 12E are formed in a substantially cylindrical shape with the front-back direction as axial direction and protrude rearward from the base 12. The fixing boss 12E on an upper side is disposed above the switch hole 12C, and the fixing boss 12E on a lower side is disposed below the lifter hole 12D.

On the rear surface of the base 12, behind the insertion hole 12B, there is an arm housing 12F for housing the lid arm 22 described further below. The arm housing 12F is formed in a substantially box shape open to the rear side and protruding rearwardly from the base 12. The lower portion of the arm housing 12F communicates with the insertion hole 12B, and the upper portion of the arm housing 12F protrudes above the base 12.

### Lid 20

Lid 20 is formed in the substantially rectangular plate shape with the front-back direction as the thickness direction. The lid 20 is disposed on the front side (obverse side) of the base 12 and within the recess 82 to close the opening 82A of the vehicle (the position illustrated in FIG. 1 and FIG. 2, hereafter referred to as a closed position of the lid 20). In the closed position of the lid 20, a surface of the lid 20 is disposed such that it is flush with the surface of the outer panel 80.

Lid 20 has a lid arm 22. The lid arm 22 is formed in a substantially U-shape that is open to the front side in a side view viewed from the left-right direction. Specifically, the lid arm 22 has a first arm portion 22A comprising an upper end of the lid arm 22 and a second arm portion 22B comprising a lower portion of the lid arm 22. The first arm portion 22A extends in the front-back direction and is slightly inclined upward toward the rear side in the side view. An arm hole 22C (see FIG. 2) is formed through a front end of the first arm portion 22A in the left-right direction. The second arm portion 22B is extended from a rear end of the first arm portion 22A downwardly diagonally forwardly, and the front end of the second arm portion 22B is connected to the upper end of the left portion of the lid 20. More particularly, the second arm portion 22B is curved in an arc shape centering on the arm hole 22C in the side view, and the front end of the second arm portion 22B is extended in the front-back direction. The lid arm 22 is housed in the arm housing 12F of the base 12, and the front end of the second arm portion 22B is inserted through the insertion hole 12B in the base 12.

A hinge shaft 24 with the left-right direction as the axial direction is inserted into the arm hole 22C of the lid arm 22 so as to be integrally rotatable. The longitudinal ends of the hinge shaft 24 project outward from the lid arm 22 in the left-right direction and are supported to allow rotation (actuation) in the arm housing 12F. As a result, the lid 20 is rotatably coupled to the base 12 with the left-right direction as the axial direction. Specifically, the lid 20 is configured to rotate between the closed position and the open position (the position illustrated in FIG. 3), which is rotated from the closed position to said one side in the rotational (actuation) direction (arrow A direction in FIG. 2) by driving the actuator 30 described further below. In the open position of the lid 20, the lid 20 is disposed above the opening 82A of the vehicle and the opening 82A is opened. In the open position of the lid 20, the first arm portion 22A is disposed adjacent to the rear side of the base 12.

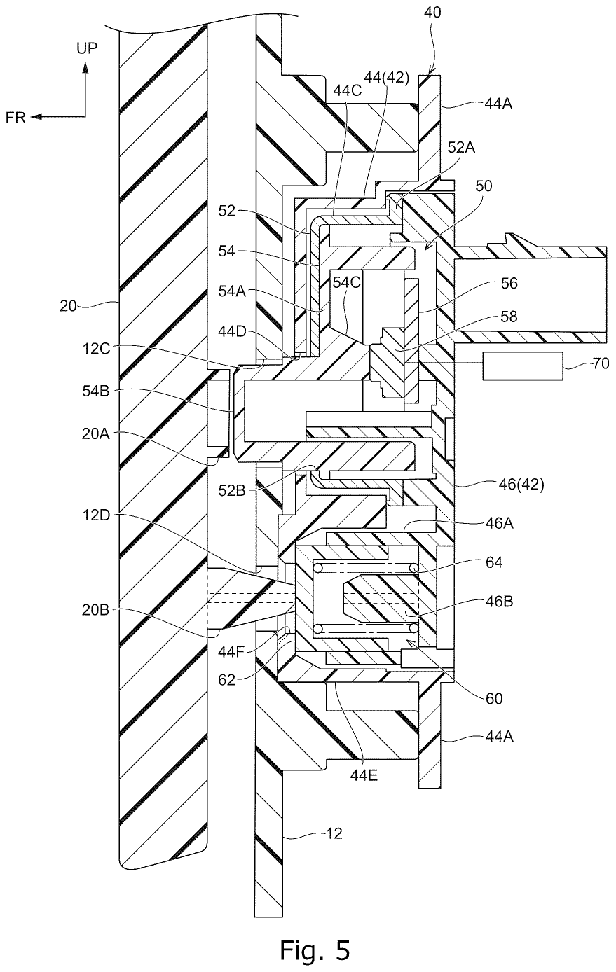

As illustrated in FIG. 1 and FIG. 5, a switch presser 20A is provided on the rear surface of the lid 20 at a position opposite to the switch hole 12C of the base 12 in the front-back direction. The switch presser 20A is formed in the substantially cylindrical shape with the front-back direction as the axial direction and protrudes rearwardly from the lid 20. The switch presser 20A is disposed spaced apart from the front side of the base 12.

On the rear surface of the lid 20, a lifter presser 20B is provided at the position opposite to the lifter hole 12D of the base 12 in the front-back direction. The lifter presser 20B is formed in a substantially cross-shaped column shape extending in the front-back direction and protruding rearwardly from the lid 20. Specifically, the lifter presser 20B has a pair of pressure pieces extending in the front-back direction, with one pressure piece arranged with the up-down direction as the thickness direction and the other pressure piece arranged with the left-right direction as the thickness direction. The lifter presser 20B is tapered so that the front-back and up-down dimensions of the lifter presser 20B become smaller toward the rear side. The lifter presser 20B is inserted through the lifter hole 12D, and the rear end of the lifter presser 20B protrudes rearwardly from the base 12.

### Actuator 30

As illustrated in FIG. 1 to FIG. 4, the actuator 30 is a drive source for rotating the lid 20. The actuator 30 comprises an actuator body 32 and a drive shaft 34 (see FIG. 1). The actuator body 32 is disposed on a left side of the arm housing 12F of the base 12 and is fixed to the arm housing 12F. The drive shaft 34 extends from the actuator body 32 to the right side with the left-right direction as the axial direction. The drive shaft 34 is coaxially disposed with the hinge shaft 24 and is coupled to the hinge shaft 24 so as to be able to rotate integrally. The actuator 30 is electrically connected to a controller 70 of the vehicle (see FIG. 1), which drives and controls the actuator 30. When the actuator 30 is driven, the drive shaft 34 rotates about its own axis, causing the lid 20 to rotate between the closed and open positions.

### Switch Unit 40

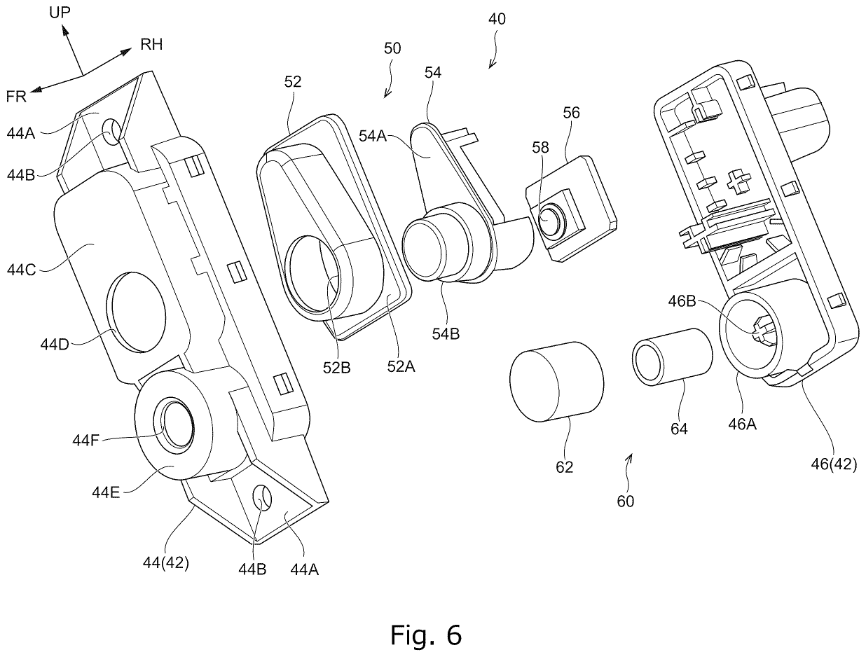

As illustrated in FIG. 5 and FIG. 6, the switch unit 40 is disposed at a lower rear side at the right end of the base 12. The switch unit 40 comprises a unit case 42, a switch 50, and a lifter mechanism 60. The unit case 42 configures an outer casing of the switch unit 40. The unit case 42 has a case body 44 and a cover case 46. The case body 44 is formed in a substantially rectangular box shape extending in up-down direction as a whole and open to the rear side. At both ends of the case body 44 in the up-down direction, a fixing piece 44A is provided, with the front-back direction as the thickness direction. A fixing hole 44B is formed through the fixing piece 44A in the front-back direction. A fixing screw (not illustrated) inserted into the fixing hole 44B from the rear side is screwed to the fixing boss 12E of the base 12 to fasten and fix the fixing piece 44A (switch unit 40) to the base 12.

The upper portion of the case body 44 is provided with a switch housing recess 44C for housing the switch 50 described further below. The switch housing recess 44C is formed in a substantially rectangular concave shape with the up-down direction as the longitudinal direction and open to the rear side. A circular-shaped first switch hole 44D is formed through a bottom end of a bottom wall of the switch housing recess 44C in the front-back direction. The first switch hole 44D is coaxially disposed with the switch hole 12C in the base 12 and has a larger diameter than the switch hole 12C. The lower portion of the case body 44 is provided with an outer cylinder 44E as a lifter holder for holding a lifter knob 62 of the lifter mechanism 60 described further below. The outer cylinder 44E is formed in a substantially bottom cylindrical shape open to the rear side and is coaxially disposed with the lifter hole 12D in the base 12. A circular lifter hole 44F is formed through the center of the bottom wall of the outer cylinder 44E in the front-back direction. The lifter hole 44F has the larger diameter than the lifter hole 12D.

The cover case 46 is formed in the rectangular box shape with a relatively shallow bottom that extends to up-down direction and is open to the front side. The cover case 46 is fixed to the rear end of the case body 44 by a claw fit and seals the switch housing recess 44C and the outer cylinder 44E from the rear side. The bottom end of the cover case 46 is provided with an inner cylinder 46A. The inner cylinder 46A is formed in the substantially cylindrical shape with the front-back direction as the axial direction and protrudes from the cover case 46 toward the front side. The inner cylinder 46A is coaxially disposed with the outer cylinder 44E of the case body 44, and a front portion of the inner cylinder 46A is disposed within the outer cylinder 44E. The cover case 46 is provided with a support column 46B in the inner cylinder 46A. The support column 46B is formed in the substantially cross-shaped column shape extending in the front-back direction and protruding from the cover case 46 to the front side.

### Switch 50

The switch 50 comprises a switch case 52, a switch knob 54, a switch substrate 56, and a switch body 58. The switch case 52 is formed in the concave shape open to the rear side. At the rear end of the outer circumference of the switch case 52, an outwardly protruding flange portion 52A is formed, and an outer shape of the flange portion 52A is formed in the substantially rectangular shape with the up-down direction as the longitudinal direction in the front view. The switch case 52 is housed in the switch housing recess 44C of the case body 44, and the flange 52A is sandwiched in the front-back direction by the case body 44 and cover case 46 to fix the switch case 52 to the unit case 42. A circular-shaped second switch hole 52B is formed through the lower portion of the switch case 52 in the front-back direction. The second switch hole 52B is coaxially disposed with the first switch hole 44D in the case body 44 and is slightly smaller in diameter than the first switch hole 44D.

The switch knob 54 has a knob base portion 54A. The knob base portion 54A is housed in the switch case 52 and is movably supported in the front-back direction by the cover case 46 and the switch case 52. Specifically, the switch knob 54 is movable from a non-pressing position (the position illustrated in FIG. 5) to the rear side. In the non-pressing position of the switch knob 54, a forward movement of the switch knob 54 is restricted by the switch case 52. The switch knob 54 has a knob portion 54B. The knob portion 54B is formed as a substantially stepped bottomed cylindrical shape open to the rear side and protruding to the front side from the lower portion of the knob base portion 54A. The rear portion of the knob portion 54B has the larger diameter than the front portion of the knob portion 54B. In the non-pressing position of the switch knob 54, the knob portion 54B inserts through the second switch hole 52B of the switch case 52, the first switch hole 44D of the case body 44, and the switch hole 12C of the base 12. The front end of the knob portion 54B protrudes forward from the base 12 and is disposed behind the switch presser 20A of the lid 20 with a predetermined gap.

The switch substrate 56 is formed in the substantially rectangular plate shape with the front-back direction as the thickness direction. The switch substrate 56 is housed in the unit case 42 behind the switch knob 54 and is fixed to the unit case 42, sandwiched front to back by the cover case 46 and the switch case 52.

The switch body 58 is a push switch. The switch body 58 is provided on the front side of the switch substrate 56 and is electrically connected to the controller 70. The switch knob 54 described above has a switch pressing column 54C. The switch pressing column 54C is formed as the substantially cross-shaped column shape extending in the front-back direction and is disposed adjacent to the front side of the switch body 58. The switch body 58 is switched from off to on when the switch knob 54 moves from the non-pressing position to the rear side and the switch pressing column 54C presses the switch body 58. This causes the switch body 58 to output an ON signal to the controller 70.

### Lifter Mechanism 60

The lifter mechanism 60 comprises the lifter presser 20B of the lid 20 described above, the outer cylinder 44E and inner cylinder 46A of the unit case 42 described above, the lifter knob 62 as the lifter member, and a lifter spring 64 as a lifter forcer. The lifter knob 62 is formed in the substantially bottom cylindrical shape open to the rear side. The lifter knob 62 is housed in the inner cylinder 46A and is supported by the inner cylinder 46A to be movable in the from-back direction. Specifically, the lifter knob 62 is configured to be movable from a lift position (position illustrated in FIG. 5) to the rear. In the lift position of the lifter knob 62, the outer circumference of a front wall of the lifter knob 62 contacts an edge of the lifter hole 44F in the outer cylinder 44E to restrict the forward movement of the lifter knob 62.

The lifter spring 64 is a compression coil spring. The lifter spring 64 is disposed in the lifter knob 62 and is also externally mounted on the support column 46B of the cover case 46. The front end of the lifter spring 64 is engaged to the front wall of the lifter knob 62, and the rear end of the lifter spring 64 is engaged to the cover case 46, causing the lifter spring 64 to press the lifter knob 62 toward the front. This holds the lifter knob 62 in the lift position.

The lifter presser 20B of the lid 20 is adjacent to the front side of the lifter knob 62, and a rear end surface of the lifter presser 20B contacts the front wall of the lifter knob 62. As described in detail further below, when the lid 20 is rotated from the open position to the closed position, the lifter presser 20B presses the lifter knob 62 to other side (rear side) in direction of the lid 20 rotation (actuation) by driving the actuator 30. A biasing force of the lifter spring 64 is set so that the biasing force exerted by the lifter spring 64 on the lifter knob 62 is higher than a pressing force exerted when the lifter presser 20B presses the lifter knob 62 to the rear side by driving the actuator 30.

Furthermore, in the closed position of the lid 20, when an operator pushes a peripheral portion of the lifter presser 20B at the right end of the lid 20 toward the rear side, the lid 20 is deflected and deformed rearward. Therefore, when the operator pushes the lid 20 rearward against the biasing force of the lifter spring 64, the lifter presser 20B presses the lifter knob 62 rearward, causing the lifter knob 62 to move rearward. At this time, the switch presser 20A is displaced rearward together with the lifter presser 20B to press the switch knob 54 of the switch 50. As a result, the switch knob 54 is displaced rearward from the non-pressing position, and the switch pressing column 54C presses the switch body 58, causing the switch body 58 to switch from off to on.

The lid device 10 has a position detection sensor 72 (see FIG. 1) for detecting the closed position of the lid 20, and the position detection sensor 72 is electrically connected to the controller 70. In the present embodiment, the position detection sensor 72 is a magnetic sensor and is provided on the base 12. The lid 20 has a magnet, and the position detection sensor 72 detects a magnetic flux density of the magnet and outputs an output value to the controller 70 according to magnitude of a detected magnetic flux density. In the closed position of the lid 20, the output value from the position detection sensor 72 is set to be above a threshold value. The controller 70 measures a drive current of the actuator 30 when the lid 20 rotates, and determines whether the drive current of the actuator 30 is above a predetermined value.

When the lid 20 is rotated to said one side in the direction of rotation (open position side), the controller 70 detects that the drive current of the actuator 30 is above the predetermined value, thereby detecting that the lid 20 has reached the open position. On the other hand, when the lid 20 is rotated to the other side in the direction of rotation (closed position side), the controller 70 detects that the lid 20 has reached the closed position based on the output value from the position detection sensor 72 and the drive current of the actuator 30. Specifically, the controller 70 detects that the output value from the position detection sensor 72 is above the threshold value and that the drive current of the actuator 30 is above the predetermined value, thereby allowing the controller 70 to detect that the lid 20 has reached the closed position.

### Effect

Next, the effects of the present embodiment will be described while describing the opening and closing operation of the lid 20.

### Rotational Movement of Lid 20 from Closed to Open Position

In the closed position of the lid 20, the controller 70 detects that the lid 20 is in the closed position according to the output value from the position detection sensor 72. To open the opening 82A of the vehicle, the operator pushes the peripheral portion of the lifter presser 20B at the right end of the lid 20 to the rear side against the biasing force of the lifter spring 64. This causes the right end of lid 20 to be displaced rearward, and lifter presser 20B presses lifter knob 62 rearward, causing lifter knob 62 to move rearward. At this time, the switch presser 20A of the lid 20 is displaced rearward and presses the switch knob 54 rearward. As a result, the switch knob 54 moves rearward and the switch pressing column 54C of the switch knob 54 presses the switch body 58. Thus, the switch body 58 switches from off to on, and the ON signal is output from the switch body 58 to the controller 70.

After a pushing operation on the lid 20 by the operator, the pushing operation on the lid 20 by the operator is released. As a result, the lid 20 returns to its original state due to the biasing force of the lifter spring 64 or the like. The ON signal is output from the switch body 58 to the controller 70, and the actuator 30 is driven (operated) by the controller 70, causing the lid 20 to rotate from the closed position to said one side in the direction of rotation. Here, in the open position of the lid 20, the first arm portion 22A of the lid 20 is disposed adjacent to the rear side of the base 12. As a result, when the lid 20 reaches the open position, the first arm portion 22A contacts the base 12, and the base 12 restricts the lid 20 from turning to said one side in the direction of rotation. By continuing to drive the actuator 30 in this state, the drive current of the actuator 30 exceeds the predetermined value. Therefore, the controller 70 detects that the lid 20 has reached the open position and stops driving the actuator 30.

### Rotational Movement of Lid 20 from Open to Closed Position

In the open position of the lid 20, the controller 70 detects that the lid 20 is not located in the closed position according to the output value from the position detection sensor 72. In other words, the controller 70 detects that the lid 20 is positioned in the open position. To close the opening 82A of the vehicle, the operator presses the knob portion 54B of the switch knob 54 protruding forward from the base 12 to the rear side. As a result, the switch knob 54 retracts, and the switch pressing column 54C of the switch knob 54 presses the switch body 58. Thus, the switch body 58 switches from off to on, and the ON signal is output from the switch body 58 to the controller 70.

When the ON signal is output from the switch body 58 to the controller 70, the actuator 30 is driven by the controller 70 and the lid 20 is rotated from the open position to the other side in the direction of rotation. Here, in the closed position of the lid 20, the lifter presser 20B of the lid 20 is disposed adjacent to the front side of the lifter knob 62 in the lift position. The biasing force of the lifter spring 64 biasing the lifter knob 62 in the lift position toward the front side is set larger than the pressing force of the lifter presser 20B pressing the lifter knob 62 toward the rear side by driving the actuator 30. As a result, when the lid 20 reaches the closed position, the lifter presser 20B of the lid 20 contacts the lifter knob 62 in the lift position, and the lifter knob 62 restricts the rotation of the lid 20 to the other side in the direction of rotation. In other words, with the lifter presser 20B of the lid 20 pressing the lifter knob 62, the rotation of the lid 20 in the other side in the direction of rotation is restricted. By continuing to drive the actuator 30 in this state, the drive current of the actuator 30 exceeds the predetermined value. Furthermore, when the lifter presser 20B contacts the lifter knob 62 in the lift position, the output value from the position detection sensor 72 is above the threshold value since the lid 20 is disposed in the closed position. Therefore, the controller 70 detects that the lid 20 has reached the closed position and stops driving the actuator 30.

As described above, in the lid device 10, when the lid 20 is rotated toward the closed position, the lifter presser 20B of the lid 20 presses the lifter knob 62 toward the other side in the direction of rotation by the drive of the actuator 30. The lifter knob 62 is biased forward by the lifter spring 64 and held in the lift position. Here, the biasing force exerted on the lifter knob 62 in the lift position by the lifter spring 64 is set larger than the pressing force on the lifter knob 62 by the lifter presser 20B. This means that even if the lifter presser 20B presses the lifter knob 62 in the lift position rearward by driving the actuator 30, the lifter knob 62 will remain in the lift position without moving rearward. In other words, in the closed position of the lid 20, the lid 20 is always supported from the rear side by the lifter knob 62 in the lift position. In other words, in the closed position of the lid 20, the lifter presser 20B is always in contact with the lifter knob 62 in the lift position. Therefore, the positional variation of the lid 20 in the front-back direction in the closed position of the lid 20 can be suppressed. This allows the surface of the lid 20 to be disposed flush with the surface of the outer panel 80 of the vehicle. Therefore, an appearance of the lid 20 in the closed position can be improved.

The switch 50 is provided in the switch unit 40, and when the lid 20 in the closed position is pushed rearward, the switch presser 20A of the lid 20 presses the switch body 58. In other words, a pushing force (operating force) against the lid 20 to press and operate the switch 50 is set mainly by the biasing force of the lifter spring 64. This makes it easy to set an optimum pushing force for pushing the lid 20 rearward.

In other words, from a viewpoint of improving operability for the operator during the pushing operation of the lid 20, it is desirable to set the biasing force of the lifter spring 64 low to lower the pushing force on the lid 20. However, if the pushing force on the lid 20 is set low, the right end of the lid 20 is easily displaced to the rear side. Therefore, for example, during the washing of the vehicle by a high-pressure car wash machine, the lid 20 may press against the switch 50, causing the lid 20 to open unintentionally. In this case, a convenience of the lid device 10 is reduced. Therefore, it is necessary to ensure the force to support the right end of the lid 20 from the rear side so that the lid 20 is not inadvertently displaced to the rear side. In this embodiment, as described above, the lid 20 is supported from the rear side by the lifter knob 62, which is biased by the biasing force of the lifter spring 64, and the pushing force when pushing the lid 20 to the rear side is set mainly by the biasing force of the lifter spring 64. Therefore, by setting the biasing force of the lifter spring 64 appropriately, the pushing force (operating force) on the lid 20 can be set to an optimal value considering operability and convenience. As described above, according to the lid device 10 of the present embodiment, an optimal pushing force for pushing the lid 20 to the rear side can be easily set.

The front end of the knob portion 54B of the switch knob 54 in the switch 50 protrudes forward from the switch hole 12C in the base 12. Furthermore, the lifter knob 62 is disposed rearwardly with respect to the lifter hole 12D so that it does not protrude forwardly from the lifter hole 12D in the base 12. This prevents the operator from accidentally pressing the lifter knob 62 when the operator presses and operates the knob portion 54B of the switch knob 54 in the open position of the lid 20. In other words, it is possible to prevent the operator from accidentally operating the switch knob 54 when the operator directly presses and operates the switch knob 54.

In the switch unit 40, the switch 50, the lifter knob 62, and the lifter spring 64 are housed in the unit case 42, and the outer cylinder 44E of the lifter mechanism 60 is integrally provided into the case body 44 of the unit case 42. Therefore, the switch 50 and the lifter mechanism 60 can be unitized as the switch unit 40 and assembled to the base 12. This can contribute to a reduction in the number of parts and improve the ease of assembly compared to a structure in which the switch 50 and the lifter mechanism 60 are provided separately.

Although the entire lifter knob 62 is disposed on the rear side of the base 12 in the present embodiment, a portion of the lifter knob 62 may be disposed within the lifter hole 12D in the base 12, and the majority of the lifter knob 62 may be disposed on the rear side of the base 12. For example, the knob portion extending forward from the lifter knob 62 may be provided on the lifter knob 62, and the knob portion may be disposed within the lifter hole 44F of the outer cylinder 44E and the lifter hole 12D of the base 12. In this case, the knob portion may be disposed so that the front surface of the knob portion is flush with the front surface of the base 12 so that the knob portion does not protrude from the lifter hole 12D to the front side. In this case, the length of the lifter presser 20B of the lid 20 is shorter than in the present embodiment.

The present invention is not limited to the above embodiments, but can be modified in various ways without departing from the gist thereof.

For example, in the present embodiment, the lid 20 is rotatably supported on the base 12 via the lid arm 22, and the lid 20 is configured to rotate and operate with respect to the base 12. Instead, the lid 20 may be configured to slide against the base 12 by a link mechanism, guide rail, or the like.

### EXPLANATION OF THE REFERENCE NUMERALS

10: Lid device
12: Base
12C: Switch hole
12D: Lifter hole
20: Lid
20A: Switch presser
20B: Lifter presser
30: Actuator (Driver)
42: Unit case
44E: Outer cylinder (Lifter holder)
50: Switch
60: Lifter mechanism
62: Lifter knob (Lifter member)
64: Lifter spring (Lifter forcer)
80: Outer panel (Panel)
82A: Opening

1. A lid device comprising:
a base provided inside an opening in a panel of a vehicle;
a lid operatively coupled to the base, positioned in a closed position on an obverse side of the base and closing the opening, and positioned in an open position to open the opening by operating from the closed position to one side in operating direction;
a driver coupled to the lid and driven to actuate the lid; and
a lifter mechanism provided on the base and the lid,
wherein the lifter mechanism is configured to comprise:
a lifter member provided on the base that is movable in obverse-reverse direction of the base;
a lifter forcer that forces the lifter member toward the obverse side of the base;
a lifter holder that restricts a movement of the lifter member to the obverse side and holds the lifter member in a lift position; and
a lifter presser provided on the lid and presses and moves the lifter member to a reverse side of the base when the lid in the closed position is pushed to the reverse side of the base,
wherein, when the lid is operated from the open position to the closed position, the lifter presser presses the lifter member in the closed position toward other side in the operating direction by the driver, and a biasing force exerted on the lifter member in a lift position by the lifter forcer is greater than pressing a pressing force on the lifter member by the lifter presser.

2. The lid device according to claim 1,
wherein the base is provided with a switch,
wherein the lid is provided with a switch presser configured to be able to press the switch,
wherein the switch presser presses the switch by the lid in the closed position being pushed into the reverse side of the base.

3. The lid device according to claim 2,
wherein the switch and the lifter member are disposed on the reverse side of the base,
wherein a switch hole and a lifter hole are formed on the base,
wherein a portion of the switch protrudes from the switch hole to the obverse side of the base,
wherein the lifter member is disposed on the reverse side of the base relative to the lifter hole so that it does not protrude from the obverse side of the base through the lifter hole.

4. The lid device according to claim 2,
wherein a unit case is provided on the reverse side of the base,
wherein the switch, the lifter member, and the lifter forcer are housed in the unit case, and the lifter holder is integrally provided on the unit case.
